(19) United States
(12) Patent Application Publication
(10) Pub. No.: US 2005/0029345 A1
(43) Pub. Date: Feb. 10, 2005

(54) Integrated lock, drop-box and delivery system and method

(76) Inventors: Paul Waterhouse, Copetown (CA); Jason August, Toronto (CA); John K. Stevens, Stratham, NH (US)

Correspondence Address: JASON AUGUST, 240 SUTHERLAND DRIVE, TORONTO, ON, M4G 1J3, CA

(21) Appl. No.: 10/888,372

(22) Filed: Jul. 9, 2004

Related U.S. Application Data
(60) Provisional application No. 60/485,860, filed on Jul. 9, 2003.

(51) Int. Cl. G06K 5/00

(52) U.S. Cl. 235/382

(57) ABSTRACT

A low-power lock apparatus includes a drive motor connected to a finite power supply, the drive motor including a shaft and a predetermined number of windings, and a threaded rod axially connected to the shaft, the rod having a predetermined thread pitch. The shaft can drive a deadbolt or, alternatively, it can drive an escapement pin into a strike disposed in the deadbolt and substantially transverse to the movement path thereof In either embodiment a wireless transceiver and antenna disposed within the lock assembly controls the drive motor in response to wireless signals, as from a transceiver incorporated within a wireless low-frequency access card. The number of windings and/or the thread pitch are selected to maximize a life of the finite power supply.

### BACKGROUND OF THE INVENTION

1. Field of the Invention

The present invention relates to a lock apparatus and a lock, drop-box and delivery system and method incorporating the lock apparatus, and more particularly, to a low-power lock apparatus and a lock, drop-box and delivery system and method incorporating the low-power lock apparatus.

2. Description of the Related Art

Electronic lock systems are useful in many applications such as hotel rooms, general building management, drop boxes, security areas at airports, apartment buildings, automobiles and so on. These electronic lock systems have many advantages over conventional mechanical keyed systems for control and access management of groups or individuals as well as the ability to actively track all transactions electronically at a low cost. These locks consist of an access control device and a mechanical locking device connected and controlled by the access device.

Many such electronic locks use a magnetic or a smart cards and reader as the access control device connected directly to the lock. Others may use an attached keypad that requires the user to enter a specific sequence of digits to open or unlock the mechanism. Finally, others may use a wireless system (Infra red or radio frequency) with a small transmitter placed either in a small key fob or a card. The mechanical locking devices are usually simple solenoids where a pin can be either pushed or pulled into the locked position, or an escapement system that enables a mechanical system that allows a user to mechanical pull.

A major technical challenge in the design of all mechanical locking devices is the balance between battery life, performance and cost. A simple solenoid with coil and plunger is disclosed by Gillham, Electrically Controlled Locks (U.S. Pat. No. 4,946,207). The Gillham device has a spring-loaded dead bolt and is the simplest possible lock mechanism. When the solenoid is activated the ‘bolt’is pulled back from the locking area by the coil and the door is free to open. The advantage of mechanical simplicity is attractive, but the major disadvantage of this approach is that the large current surge required to pull the solenoid open will quickly drain the batteries.

A second conventional system uses a motor that drives a set of gears to mechanically move a locking bolt into and out of a locking area (e.g., see Doong, Power Supplying Device for a Door Lock (U.S. Pat. No. 6,381,999)) and/or a set of cams (e.g., see Geringer et al., Door Locking and Monitoring Assembly to Move the Bolt In and Out (U.S. Pat. No. 4,596,411). These all tend to be mechanically complex with many moving parts that might lead to failure particularly when placed outside year round.

A third prominently used system uses a small motor to create an “escapement” mechanism, (e.g., see Doong, Door Lock (U.S. Pat. No. 6,397,646) that enables an end-user to mechanically move the lock mechanism. The so-called escapement locks are commonly used in hotel rooms and security areas. They have the advantage of using a small DC motor that can move a cam or a pin a very short distance that enables a more complex mechanical system to be turned by hand.

The advantages of the escapement locks are reduced power which results in extended battery life. However, the major disadvantage is mechanical complexity and the fact that the user must still mechanically open the lock.

Thus, conventional electric locks are complex and, therefore, expensive, and/or have a large power consumption so that the batteries must be frequently replaced.

### SUMMARY OF THE INVENTION

In view of the foregoing and other problems, disadvantages, and drawbacks of the conventional methods and structures, an object of the present invention is to provide a lock mechanism which has a low power consumption.

The present invention includes a low-power lock apparatus which includes a drive motor connected to a finite power supply, the drive motor having a shaft and a predetermined number of windings, and a threaded rod axially connected to the shaft, the rod having a predetermined thread pitch. Further, at least one of the number of windings and the thread pitch are selected to maximize a life of said finite power supply.

The present invention also includes an electric lock which includes a drive motor having a finite power supply, the drive motor having a shaft and a predetermined number of windings, a threaded rod axially connected to the shaft, the rod having a predetermined thread pitch, a traveller having a threaded bore which mates with the threaded rod so that rotation of the threaded rod causes the traveller to move along an axis of the threaded rod, and a lock member which contacts the traveller. Further, at least one of the number of windings and the thread pitch are selected to maximize a life of the finite power supply.

The present invention also includes an electric lock assembly which includes a drive motor connected to a first member and having a finite power supply, the drive motor having a shaft and a predetermined number of windings, a threaded rod axially connected to the shaft, the rod having a predetermined thread pitch, a traveller having a threaded bore which mates with the threaded rod so that rotation of said threaded rod causes the traveller to move along an axis of the threaded rod, a lock member which contacts the traveller, said lock member having a leading end, and a strike connected to a second member, the strike having an opening for receiving the leading end so as to lock the first and second members. Further, at least one of said number of windings and said thread pitch are selected to maximize a life of said finite power supply.

Further, the finite power supply may supply pulses of electricity to the drive motor, and at least one of the number of windings and the thread pitch may be selected so as to reduce the pulses to a level selected for maximum battery life. Further, the finite power supply may include a AA-type battery (e.g., a plurality of AA batteries) and the pulses may each be less than 100 milliamps and the number of windings may be twice the windings of a conventional motor. Further, the pulses comprise approximately 50 milliamp pulses.

The present invention may also include a drop box having the electric lock assembly described above. In this case, the lock assembly controlling an access to said drop-box. For instance, the first member may include a wall of the drop box and the second member may include a door of the drop box.

The present invention also includes a system utilizing the drop box (with the inventive lock assembly) for delivery of an item. For example, the system may include an electronic tag associated with said item and comprising a first transceiver. In this case, the drop box may be located at a destination for the item. The drop-box may further include a second transceiver which wirelessly communicates with the first transceiver to open said lock assembly. In addition, the system may also include an access card having a third transceiver, for wirelessly communicating with the second transceiver to open the lock assembly.

For instance, the drop-box may include a first memory device for storing a first identification number, and the electronic tag may include a second memory device for storing a second identification number. Thus, the processor in the drop-box may the first identification number and the second identification number, and unlock (e.g., open the lock assembly) when the first identification number matches the second identification number.

The present invention also includes an inventive method which utilizes the drop box for delivery of an item. The inventive method includes associating the item with an electronic tag having a first transceiver, transporting the item to a destination, and placing the item in the drop box which is located at the destination, the drop box including a second transceiver which wirelessly communicates with said first transceiver to open the lock assembly.

The present invention also includes a programmable storage medium tangibly embodying a program of machine-readable instructions executable by a digital processing apparatus to perform a method utilizing the drop-box having the inventive lock assembly for delivery of an item.

With its unique and novel aspects, the present invention provides a lock apparatus (and lock assembly) which has a low power consumption. The lock apparatus and assembly may be used in drop-boxes and delivery systems shipping containers, storage sheds, and methods incorporating the low-power lock assembly, to provide a low-cost, simple, secure locking mechanism, the batteries of which seldom, if ever, need to be replaced or recharged.

As a fifth embodiment, the present invention provides (as illustrated by way of mere example by FIGS. 12 and 13) an integrated mechanical and electric lock assembly for locking together a first member and a second member with a deadbolt member carried by said first member, the lock assembly comprising:
a) a first lock assembly, carried by said first member, comprising:
   i) a mechanical lock adapted to be carried by said first member and operable by a mechanical key to move an unimpeded deadbolt member along a first path, said deadbolt member having a cutout therein and substantially transversely oriented to said first path;
   ii) a drive motor adapted to be carried by said first member and having a finite power supply, said drive motor comprising a rotatable shaft and a predetermined number of windings;
   iii) a threaded rod axially connected to said shaft, said rod comprising a predetermined thread pitch,
   iv) a traveller comprising a threaded bore which mates with said threaded rod so that rotation of said threaded rod causes said traveller to move along a second path substantially parallel to said threaded rod and substantially transverse to said first path;
   v) an escapement pin carried by said traveller, said escapement pin having a leading end; and
b) a deadbolt strike carried by said second member, said strike having an opening for receiving said leading end of said deadbolt member into a locking position thereof so as to lock said first and second members, said escapement pin being operable to engage said cutout in said deadbolt member as an escapement pin strike to lock said deadbolt member into said locking position thereof.

Preferably, the aforesaid lock assembly further comprises a first transceiver and an antenna operable to receive radio frequency signals (e.g. at 300 Hz or other low frequency) from a second transceiver spaced away from said lock assembly to control said drive motor and consequent movement of said escapement pin into and out of said cutout in said deadbolt member.

To simplify replacement of existing prior art locks, the first lock assembly is preferably proportioned to a size that permits substitution in the field. For this purpose, it is preferable that the aforesaid antenna be disposed in a compact configuration incorporated into said first lock assembly. For example, the compact configuration can comprise a coil disposed around a keyhole operable to receive said mechanical key.

The invention further provides a drop box that comprises the latter integrated mechanical and electric lock assembly to control an access to said drop-box. In that application, the aforesaid first member comprises a wall of said drop box and said second member comprises a door of said drop box.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates a low-power lock apparatus 100, electric lock 150 and lock assembly 175 according to the present invention;

FIG. 2 provides a graph which plots pulse current vs. capacity for a AA battery;

FIG. 3 provides a graph which plots pulse current vs. the life of a AA battery;

FIG. 4 provides a graph which plots pulse current vs. time for two lock apparatuses having differently configured motors;

FIGS. 5A-5F provide photographs of one exemplary embodiment of the lock assembly according to the present invention;

FIG. 6 provides a circuit diagram for the lock assembly according to the present invention;

FIGS. 7A and 7B illustrate a drop-box 200 includes the lock assembly 175 according to the present invention;

FIG. 8A illustrates a system 700 which utilizes the lock assembly 175 for delivery of an item according to the present invention;

FIG. 8B illustrates an electronic tag 210 used in the inventive system according to the present invention;

FIGS. 9A and 9B illustrate an access card 900 which may be included in the inventive system 700 according to the present invention;

FIG. 9C illustrates a keypad 1000 that may be used in the system 700 according to the present invention;

FIG. 10 illustrates an access card 900 and lock assembly 175 according to the present invention; and

FIG. 11 is a flow chart illustrating an inventive method 1100 for delivering an item according to the present invention.

FIG. 12 is an outer perspective view of a first lock assembly of an integrated mechanical and electric lock assembly, as a fifth embodiment of the present invention.

FIG. 13 is an inner perspective view of a first lock assembly of an integrated mechanical and electric lock assembly, as a fifth embodiment of the present invention.

### DETAILED DESCRIPTION OF THE PREFERRED EMBODIMENTS

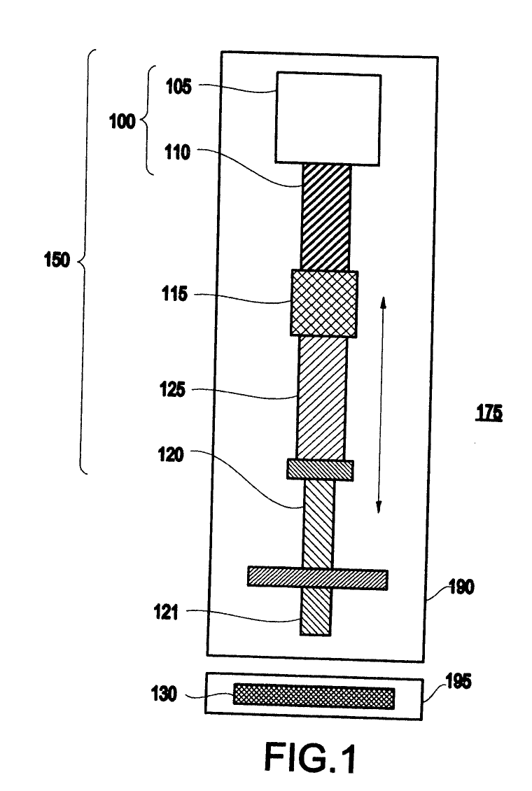

Referring now to the drawings, FIG. 1 illustrates an inventive low-power lock apparatus 100 according to the present invention. The inventive lock apparatus 100 includes a drive motor 105 connected to a finite power supply (e.g., a battery). The drive motor includes a shaft and a predetermined number of windings. The apparatus also includes a threaded rod 110 axially connected to the shaft, the rod having a predetermined thread pitch. Further, at least one of the number of windings and the thread pitch are selected to maximize a life of the finite power supply.

In general, the inventors have developed a lock mechanism (e.g., a wireless dead-bolt lock) that may require no mechanical assistance to open, can be self-contained with only a single moving part. The inventive lock mechanism may, therefore, be made “tamper-proof”, self-contained, wireless and have only a single moving part. Further, the inventive lock can be “tuned” to reduce (e.g., minimize) power consumption and improve (e.g., maximize) battery life.

The expected battery life of an AA alkaline battery is five to seven years or 25,000 cycles. For C or D alkaline batteries, the expected battery life maybe as much 10 or more years. Locks with an escapement mechanism and other locks typically have battery lives of two to three years maximum. In most cases these locks require at least four AA batteries, and in some cases C batteries. In addition, escapement locks require complex mechanical and electrical connections to the outside world.

Lock mechanisms are commonly used to secure the doors of drop-boxes used in courier delivery systems (e.g., unattended and overnight delivery systems). Such drop-boxes (e.g., relay boxes) often include a battery-powered electric lock mechanism, and may be used by couriers and post offices to pick-up and drop-off delivered parcels and mail at a location. Thus, such drop-boxes allow deliveries to be made overnight or when the owner is not present (e.g., unattended delivery).

Long battery life is particularly important in such drop-box field applications. The expense of changing batteries in an electronic lock in these applications is high. Further, mechanical “keyed” locking systems are difficult to manage and maintain with many thousands of employees requiring access.

As shown in FIG. 1, the inventors have designed an extremely simple (e.g., mechanical) low-power lock apparatus 100 that makes it possible to improve (e.g., optimize) battery life and balance mechanical performance and reliability, and reduce (e.g., minimize) cost. Moreover, the same basic design can be quickly adapted to many different locking applications with larger or smaller bolts, or longer or shorter closing distances, and yet maintain and reduce (e.g., optimize) power consumption from batteries to in order to improve (e.g., maximize) battery life.

Further, the inventive lock apparatus100 may improve battery life by changing two (e.g., only two) key electrical/mechanical parameters. Battery capacity is generally rated in amp-hours (AH) (e.g., the total number of hours a battery is capable of producing over a period of time). However, alkaline batteries, the least expensive source of battery power, have different amp-hour capacities depending upon the actual current needed over time.

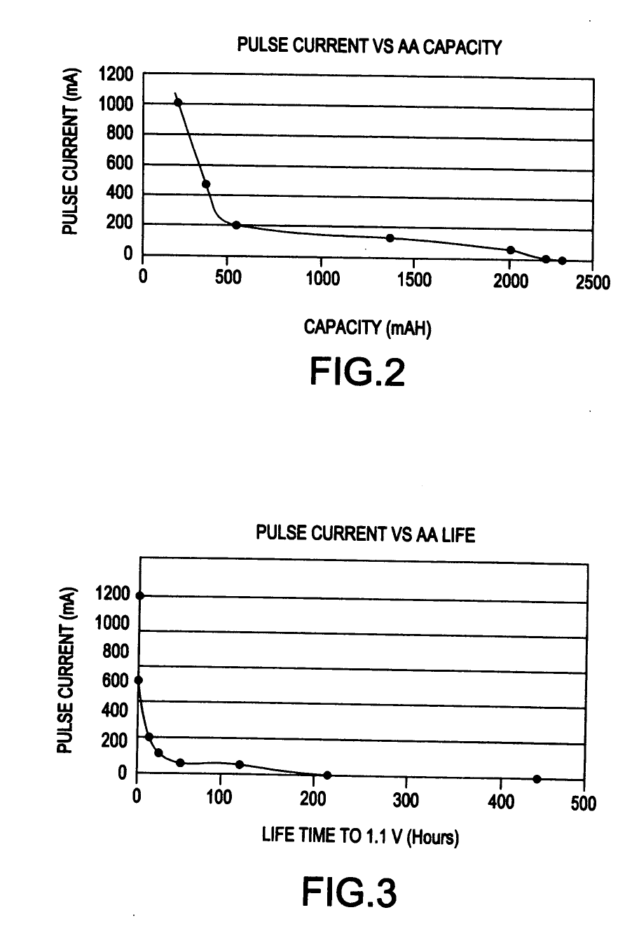

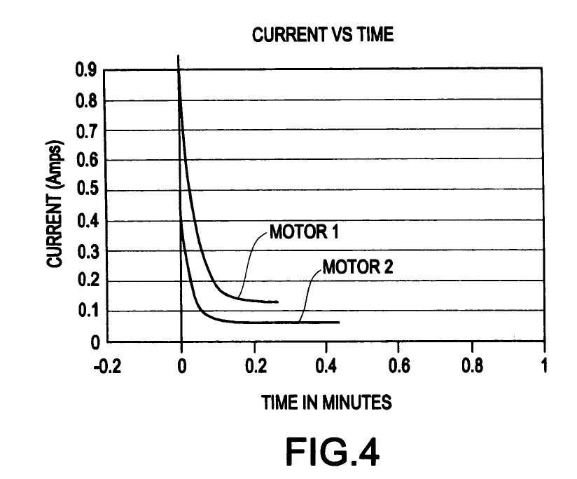

FIG. 2 provides Graph 1 which shows the capacity in milliamp-hours (mAH) for an AA battery. If the current source drains the battery with 1000 mA pulses, capacity is severely reduced to about 200 mAH. But if the current pulses are reduced to 50 mA, the total battery has a capacity of over 2000 mAH. The life of a AA battery (voltage reduced down to 1.1 Volts) is, therefore, not determined so much by total current drain, but by peak current or pulse current as shown by Graph 2 provided in FIG. 3. Thus, if the energy or power required to move a deadbolt from a locked position to an un-locked position etc. is distributed (e.g., optimally distributed) over time to minimize the peak power drain from the battery, the lock may be designed so that it uses the same power in mAH.

It is possible to use a simple electronic circuit to limit current, such as adding a resistor, to a motor to achieve this result. However, such an approach would also limit the torque to the motor, leading to unreliable opening and closing, especially in severe cold or heat.

Further, an efficient method for minimizing current drain over time is to manufacture a special motor with many additional windings, thereby increasing the resistance but maintaining maximum torque. However, this would slow the motor down and increase the time it takes to open or close the lock, again increasing the total current drain.

The inventors, however, have discovered (e.g., using the design shown in FIG. 1), that it is possible to modify the thread pitch of the threaded rod 110 and the windings on the motor 105 so as to maintain enough power and reduce (e.g., minimize) the time to open/close the lock so as to optimize battery life. The inventors analyzed the inventive lock apparatus and some of the test results are provided in Graph 3 which is illustrated in FIG. 3.

Specifically, the graph in FIG. 3 plots current vs. time for two lock apparatuses (identified as Motor 1 and Motor 2) having different motor configurations. Motor 1 is a standard motor with conventional windings and has a total power consumed of about 0.057 AH per opening (or closing). Motor 2, on the other hand, has more windings than Motor 1 (e.g., approximately twice the number of windings). In addition, the thread pitch of the threaded rod used with Motor 2 is greater than that of lock apparatus using Motor 1. The inventors discovered that Motor 2 has a peak power drain which is 50% less than Motor 1 and consumes only 0.041 AH.

Thus, battery life may be significantly extended by using motor 2 (e.g., having a combination of increased windings and modified (e.g., increased) thread pitch) as compared to motor 1. Indeed, the inventors have been able to extend battery life from one to two years to over five years using AA batteries by optimizing these two components (e.g., windings and thread pitch).

More specifically, in the low power lock apparatus 100, the finite power supply may supply pulses of electricity to the drive motor, and at least one of the number of windings and the thread pitch may be selected so as to reduce the pulses to a level selected for maximum battery life. For instance, the finite power supply may include a AA-type battery, the pulses may each be less than 100 milliamps, and the number of windings may be twice the windings of a conventional motor. Further, the pulses may include approximately 50 milliamp pulses.

### Second Embodiment

Referring again to the drawings, FIG. 1 also illustrates an electric lock 150 which may include the lock apparatus 100. Specifically, the electric lock 150 includes a drive motor 105 having a finite power supply (e.g., a battery), the drive motor 105 including a shaft and a predetermined number of windings, a threaded rod 110 axially connected to the shaft, the rod 110 including a predetermined thread pitch, a traveller 115 (e.g., a square nut) having a threaded bore which mates with the threaded rod 110 so that rotation of the threaded rod 110 causes the traveller to move along an axis of the threaded rod 110, and a lock member 120 (e.g., a hard steel bolt) contacting the traveller. The electric lock 150 may also include a tube or guide 125 (e.g., a hollow tube) through which the lock member 120 may slide back and forth. Further, the number of windings of the drive motor 105 and/or the thread pitch of the threaded rod 110 are selected to maximize a life of the finite power supply. battery, the pulses may each be less than 100 milliamps, and the number of windings may be twice the windings of a conventional motor. Further, the pulses may include approximately 50 milliamp pulses.

### Second Embodiment

Referring again to the drawings, FIG. 1 also illustrates an electric lock 150 which may include the lock apparatus 100. Specifically, the electric lock 150 includes a drive motor 105 having a finite power supply (e.g., a battery), the drive motor 105 including a shaft and a predetermined number of windings, a threaded rod 110 axially connected to the shaft, the rod 110 including a predetermined thread pitch, a traveller 115 (e.g., a square nut) having a threaded bore which mates with the threaded rod 110 so that rotation of the threaded rod 110 causes the traveller to move along an axis of the threaded rod 110, and a lock member 120 (e.g., a hard steel bolt) contacting the traveller. The electric lock 150 may also include a tube or guide 125 (e.g., a hollow tube) through which the lock member 120 may slide back and forth. Further, the number of windings of the drive motor 105 and/or the thread pitch of the threaded rod 110 are selected to maximize a life of the finite power supply.

### Third Embodiment

Referring again to the drawings, FIG. 1 illustrates an electric lock assembly 175 which may include the lock apparatus 100. Specifically, the assembly 175 includes a drive motor 105 connected to a first member (e.g., a door or wall of a drop-box) and having a finite power supply (e.g., a battery) 106, the drive motor 105 including a shaft and a predetermined number of windings, a threaded rod 110 axially connected to the shaft, the rod 110 including a predetermined thread pitch, a traveller 115 (e.g., a square nut) having a threaded bore which mates with the threaded rod 110 so that rotation of the threaded rod 110 causes the traveller to move along an axis of the threaded rod 110, and a lock member 120 (e.g., a hard steel bolt) contacting the traveller, the lock member having a leading end 121, and a strike 130 connected to a second member (e.g., a door or wall of a drop-box). For instance, the strike 130 may have an opening for receiving the leading end 121 of the lock member 120 so as to lock the first and second members.

The electric lock assembly 175 may also include a tube or guide 125 (e.g., a hollow tube) through which the lock member 120 may slide back and forth. Further, the number of windings of the drive motor 105 and/or the thread pitch of the threaded rod 110 are selected to optimize (e.g., maximize) a life of the finite power supply 106, while ensuring a reliable operation of the lock assembly 175.

As noted above, the inventive lock assembly 175 may include a motor with a threaded rod mounted to the motor's shaft. The threaded shaft may move a square nut which may be prevented from rotation (e.g., by being flush to the mounting plate that holds the motor). The nut may have a hollow tube attached so that the threaded rod can freely move the nut back and forth. The tube, for example, may be attached to a solid hardened-steel bolt that may serve as the lock member (e.g., locking mechanism).

Thus, the lock assembly 175 in its simplest embodiment may include very few (e.g., two) moving parts. The motor and threaded shaft can be tuned or matched by changing the number of windings on the motor and/or the pitch of the thread. As the windings increase, the motor's speed decreases, and as the pitch of the thread is increased, the total time to open and close the lock can be increased. This mechanical arrangement helps to allow a design that can be used to minimize peak power, and minimize the time required to open or close the lock assembly, yet maintain adequate motor torque so the lock assembly opens/closes (e.g., unlocks/locks) reliably. Therefore, regardless of the size of the lock required (e.g., regardless of the weight of the dead-bolt required) the design of the inventive lock assembly can be used to maximize battery life.

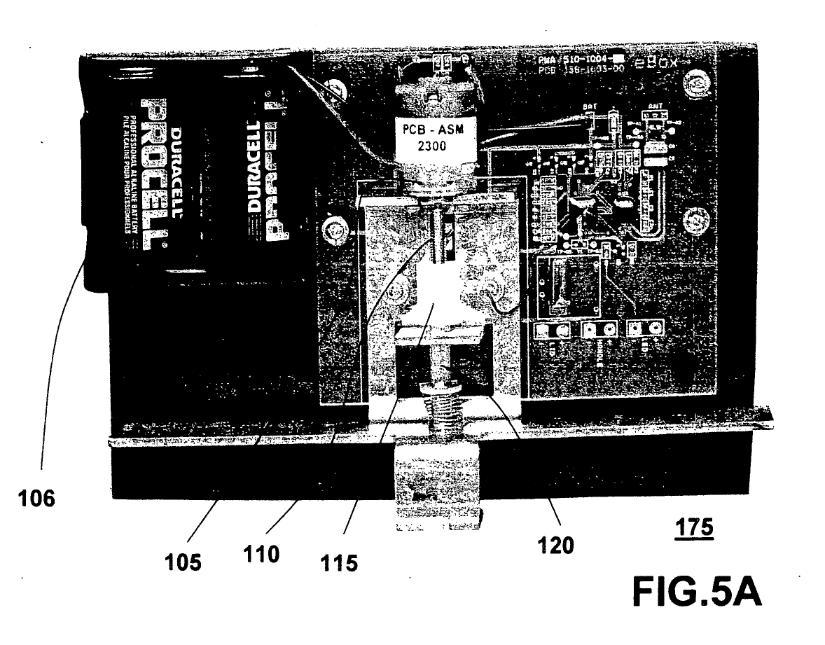

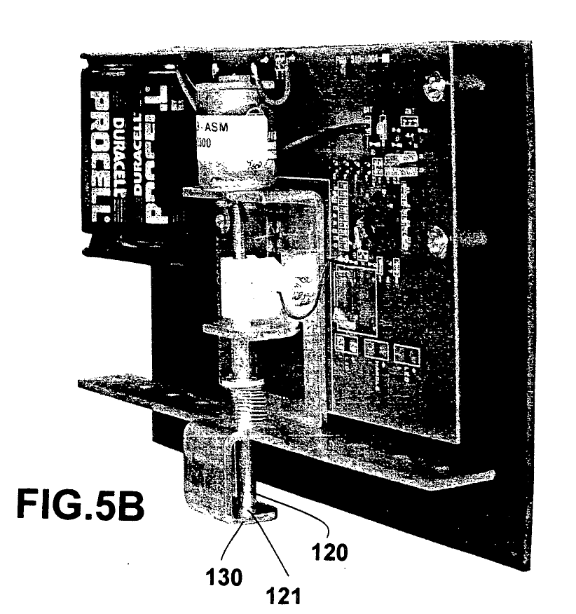

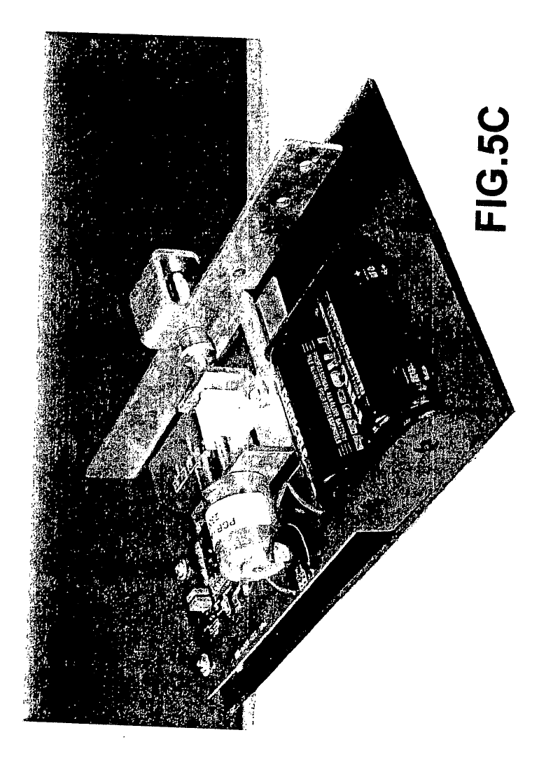

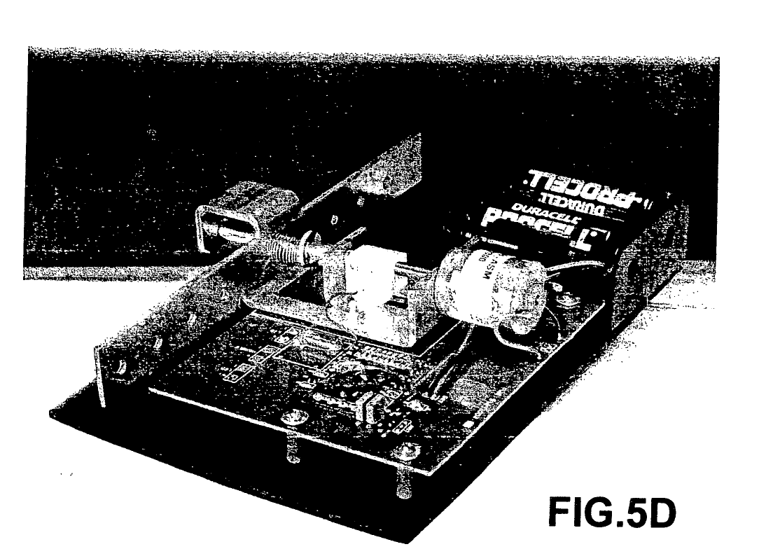

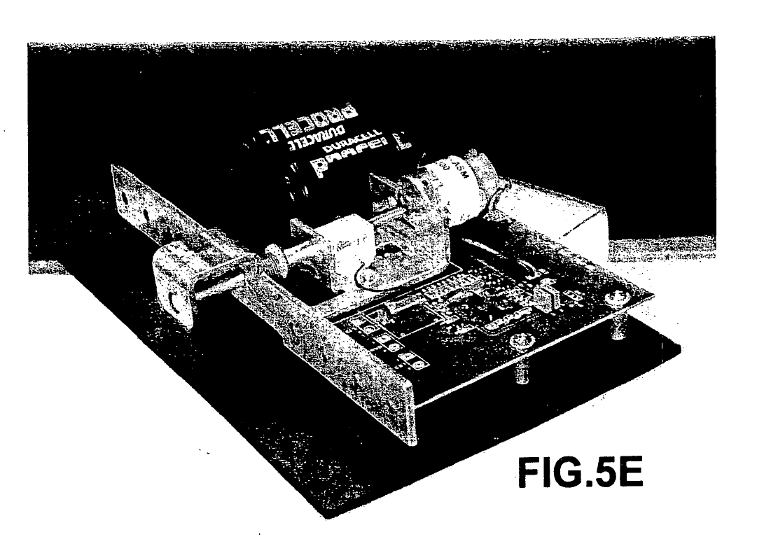

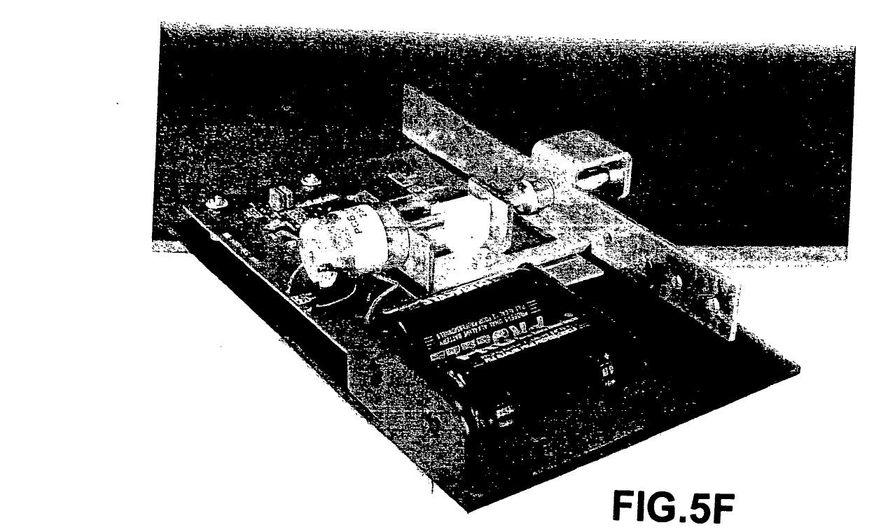

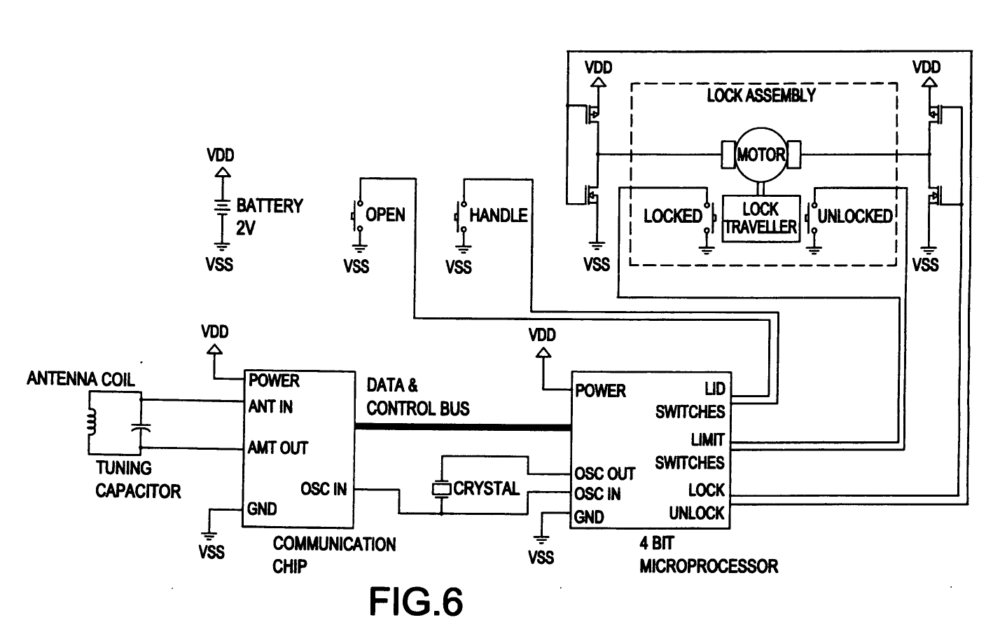

FIGS. 5A-5F provide photographs of an exemplary electric lock assembly 175 according to the present invention. FIG. 6 provides a circuit diagram for this exemplary embodiment of the electric lock assembly 175.

As shown here, the assembly includes contacts near (e.g., under) the threaded rod which are used to deactivate the motor (e.g., stop the motor from turning) when the lock member has been adequately retracted/extended (e.g., opened/closed).

Further, the spring shown in the photograph helps to slow the advancement (e.g., extension) of the lock member 120 toward the strike member 130. It should be noted that the spring is not be necessary.

In addition, although it is not shown in the photographs of FIGS. 5A-5F, when the lock assembly 175 is in an open position (e.g., when the lock member 120 is retracted), the traveller 115 does not contact the lock member 120 (or hollow tube 125). This helps to ensure that there is little load on the motor when it initially activated to close the lock, resulting in a lower initial peak in power consumption.

### Fourth Embodiment

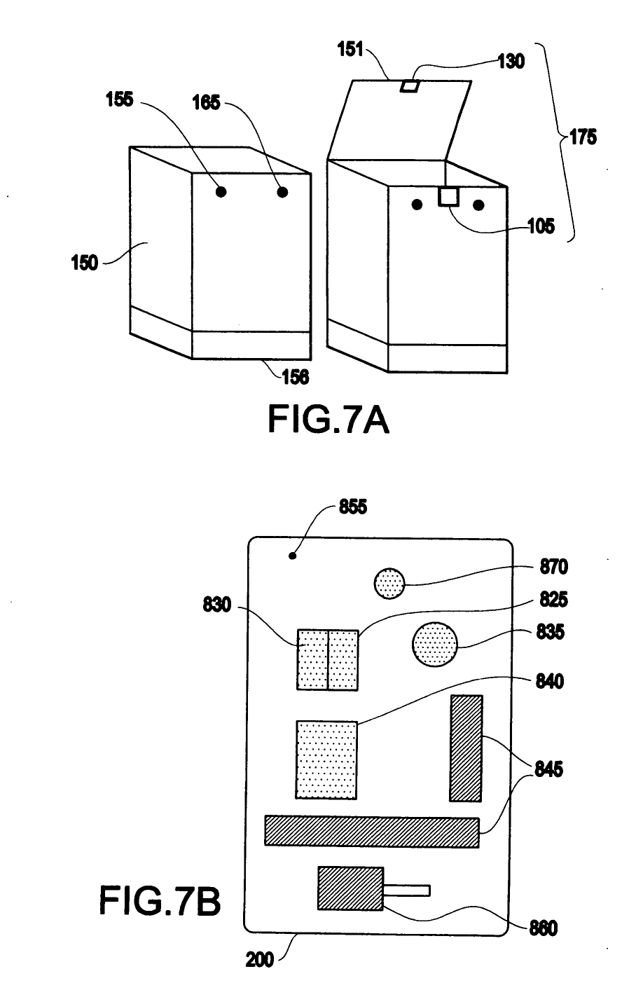

Referring again to the drawings, FIG. 7A illustrates a drop-box 200 which includes the inventive electric lock assembly 175. The drop-box 200 may be similar in design and function to the drop-box disclosed by Stevens, et al., Delivery System and Method Using Electronic Tags (International App. No. PCT/US02/12903) and Stevens, System and Method for Unattended Delivery (International App. No. PCT/US02/16019) which are assigned to the present assignee and incorporated herein by reference.

The drop-box 200 may be used, for example, by couriers and post offices to pick-up and drop-off delivered parcels and mail at a location. For instance, the first member of the assembly 175 (to which the drive motor 105 is connected) may include a wall of the drop-box and the second member of the assembly 175 (to which the strike 130 is connected) may include a door of the drop box 200.

More specifically, as shown in FIG. 7A, the drop-box 200 may include a door or lid (e.g., hinged door or lid) 151 which may be opened to access the space inside the drop box 150. The drop-box 200 may also include a signaling device 155 (e.g., a light-emitting device (e.g., LED) or an audible device) which is activated to signal to the driver where the goods are to be delivered. The box 200 may also include a switch 165 (e.g., a button) located, for example, on the outside of the box to activate and deactivate the security features of the box 200. The box 200 may also be secured to a dock 156 which may be used, for example, to lock the box 200 in a stationary position and provide other features to the box 200 (e.g., temperature control and/or humidity control features).

In addition, as shown in FIG. 7B, the drop-box 200 may include, for example, a processor 825 (e.g., a fixed programmed four bit microprocessor), a memory device 830 (e.g., random access memory (RAM)) and a power source 835 (e.g., a lithium battery). The drop-box 200 may also include a transceiver 840 (e.g., a custom two-way communication analog chip) and an antenna 845 to transmit and receive data over a short range link. As mentioned above, the power source 835 (e.g., battery) should have a long service life (e.g., over five years) over many (e.g., several thousand) transactions.

Further, the drop-box 200 may also optionally include a light-emitting device 855 (e.g., one or two light emitting diodes) that can be optionally used to identify a correct package when a delivery driver arrives. In addition, as shown in FIG. 2B, the antenna 845 in the drop-box 200 may include a larger loop antenna for improved two-way communication.

In addition, the drop-box 200 may be insulated to facilitate the delivery of sensitive (e.g., perishable) goods. The space inside the insulated drop-box may range, for example, from between about 1 cubic foot to 30 cubic feet. The temperature inside the box 200 may be controlled to between about 35 and 85 degrees Fahrenheit.

The drop-box 200 may also be formed of a variety of materials, such as plastic or metal, and may have good insulative properties. The lid of the box may also have a tight seal. Further, to insulate the drop-box, the walls may be formed of a single layer of a conventional insulative material having a sufficient thickness and density to provide the desired insulative features. Alternatively, the box may be double-walled and have insulative material (e.g., a conventional insulative material) therebetween.

The drop-box 200 may also include an optional humidity control feature to regulate the amount of moisture inside the box 200. In addition, the box 200 could have a switch to activate and deactivate the temperature control and/or humidity control features.

The drop-box 200 may be locked using the electric lock assembly 175 described above. For example, as shown in FIG. 6A, the drive motor 105 may be connected to a wall of the drop-box, and the strike 130 may be connected to the door (e.g., lid) of the drop-box 200. (It should be noted that this arrangement could be reversed so that the drive motor 105 is mounted to the door and the strike 130 is mounted to the wall of the drop-box 200.)

Thus, the lock member 120 may be moved forward to lock the lid of the box 200 and rearward to unlock the box 200. As shown in FIG. 7B, the box 200 may also have a switch 870 (e.g., a button) to control an operation of the box 200. Further, when the lid is closed, the processor in the drop box 200 may automatically cause the electric lock assembly 175 to lock the box 200, or the assembly 175 may automatically lock after a predetermined period of time.

### Fifth Embodiment

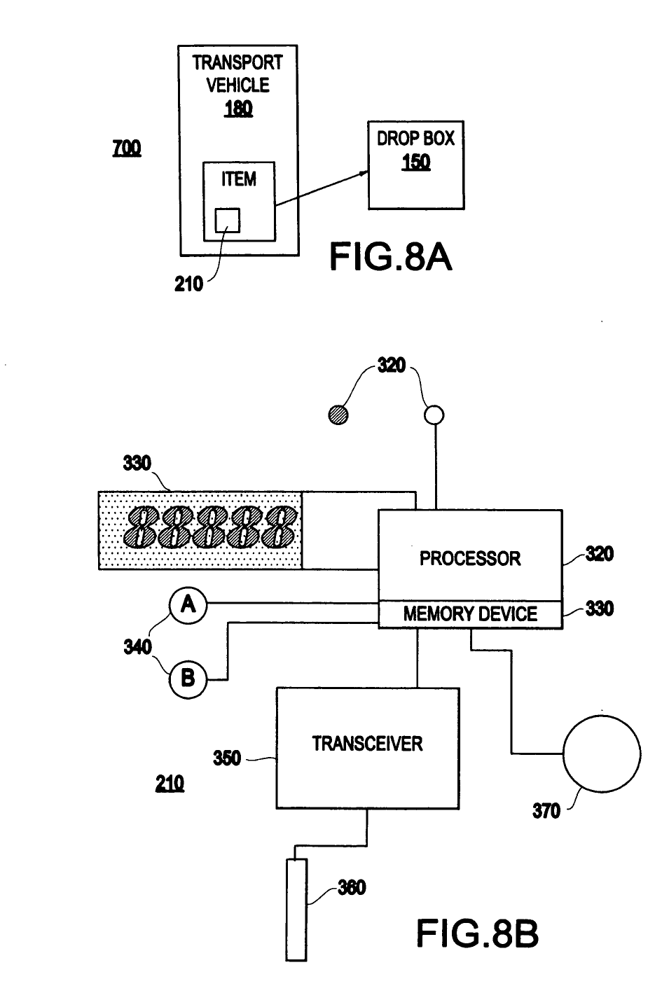

As shown in FIG. 8A, in another embodiment, an inventive system 700 utilizes the drop-box 200 for delivery of an item. The inventive system 700 may be similar in form and function to the system disclosed by Stevens et al. (PCT/US02/13903) and Stevens (PCT/US02/16019) discussed above.

For instance, in addition to the drop-box 200, the system 700 includes an electronic tag 210 associated with the item. The electronic tag 210 includes a first transceiver. Thus, the drop-box 200 may be located at a destination for the item, so that the second transceiver in the drop-box 200 may wirelessly communicate with the first transceiver (in the electronic tag 210) to allow access to the drop-box. The inventive system 700 may further include a transport vehicle 180 for transporting the item to the destination having the drop-box 200.

Further, as shown in FIG. 8B, the small electronic tag 210 may include a signaling device (e.g., a plurality of signaling devices) such as a colored (e.g., red or green) light emitting device 320 (e.g., a light emitting diode (LED) or an audible signaling device. The electronic tag 210 may also include a liquid crystal display 330 (LCD) for numeric or alphanumeric display, and a switch (e.g., plurality of switches or buttons) 340 for controlling an operation of the electronic tag 210.

As shown in FIG. 7B, the electronic tag 210 may also include an inexpensive processor 320 (e.g., a low powered four bit microprocessor), a memory device 330 (e.g., a random access memory (RAM)) or other nonvolatile memory device for storing a unique identification number. The identification number may be permanent, so that it can be changed only with a special program and transmitter.

The electronic tag 210 may also contain a transceiver 350 (e.g., a transmitter/receiver such as a two-way communication chip) for allowing the electronic tag 210 to communicate with the drop box 200 (or a base station). The two-way communications chip may be, for example, a low-cost CMOS analog/digital chip. The chip may be connected to orthogonal ferrite antennas 360 that are able to transmit and receive signals using low frequencies to the loop antenna (e.g., in the transport vehicle) wirelessly connected to the base station.

For instance, the drop-box 200 may include a first memory device for storing a first identification number, and the electronic tag 210 may include a second memory device for storing a second identification number. Thus, the processor in the drop-box 200 may the first identification number and the second identification number, and unlock (e.g., open the lock assembly 175) when the first identification number matches the second identification number.

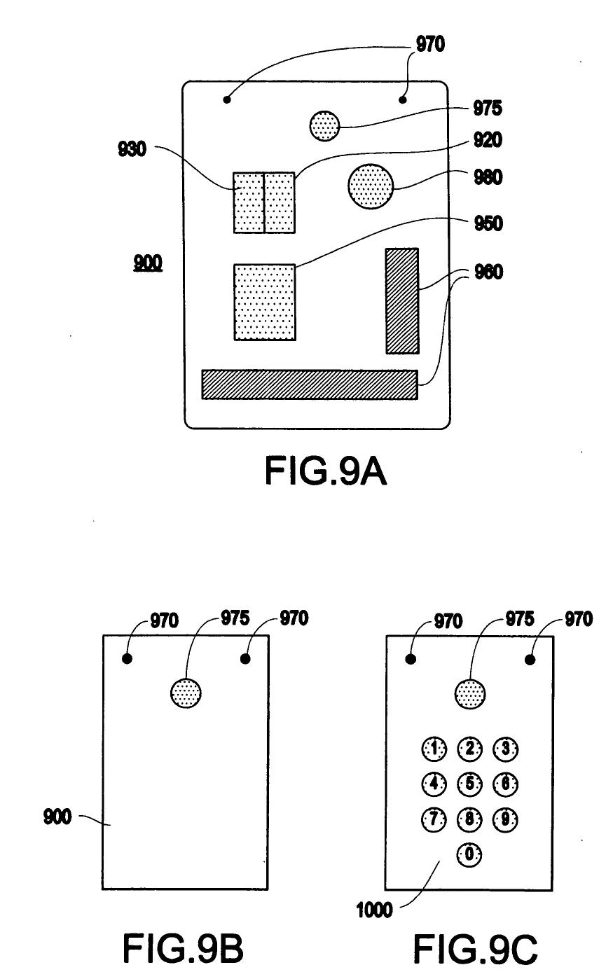

As shown in FIG. 9A, the system 700 may also include an access card 900 which has a third transceiver, for wirelessly communicating with the second transceiver (in the drop-box 200) to access the drop-box 200. For instance, instead of using the electronic tag 110 to access the drop box, the deliveryman may use the access card 900. Similarly, after the item has been delivered the drop-box 200, the customer (e.g., home or business owner of the destination for the item) may later (e.g., the next morning), open the drop-box 200 and remove the goods using an access card 900.

Further, the access card 900 which allows access to the drop-box 200 may include a short range wireless link to control a lock mechanism (e.g., a battery operated lock mechanism) contained in the drop-box 200. The access card may include an inexpensive processor 920 (e.g., a low powered four bit microprocessor), a memory device 930 (e.g., a random access memory (RAM)) or other nonvolatile memory device for storing a unique identification number. The identification number may be permanent, so that it can be changed only with a special program and transmitter. The access card 900 may also contain a switch 975 (e.g., a button) to control an operation of the access card 900.

The access card 900 may also contain a transceiver 950 (e.g., a transmitter/receiver such as a two-way communication chip) for allowing the access card 900 to communicate with the drop-box 200 and other devices in the inventive system 100 (e.g., the base station 120). The two-way communications chip may be, for example, a low-cost CMOS analog/digital chip. The two-way communications chip may be connected to orthogonal ferrite antennas 960 that are able to transmit and receive using low frequencies to the loop antenna connected to the base station. Further, the access card 900 may wirelessly communicate with other devices via a bi-directional wireless link. The wireless link may include, for example, a low frequency conductive loop requiring minimal power and allowing communication within a small area. Further, the access card may include display devices 970 (e.g., light emitting diodes) which may be programmed to display both numeric as well as alphanumeric information transmitted to the access card 900. The circuitry may be solar powered or powered, for example, by a battery 980 or other power source. Battery life using conventional alkaline batteries is likely to exceed five years, and with AAA batteries the life maybe longer. As mentioned above, a record of opening and closing times can be kept in the memory of the drop-box 200 so that when the driver opens the box 200 to place an order he can “harvest” this information.

Further, as shown in FIG. 9B, the access card 900 might have a single button 975 and one or two display devices 970 (e.g., light emitting diodes) to indicate the status of the box 200.

Alternatively, as shown in FIG. 9C, the box 200 (or access card 900) may have a small keypad 1000 to enter in a Personal Identification Number (PIN). The keypad 1000 would allow the driver to program the security level of the access to the box 200 when placing an order using the access card. For instance, if it is a high security item the box 200 could open only with a one time use PIN. For lower security, a standard PIN known by the customer may be used, and for low security items the driver may not enter a PIN.

Further, the access card 900 having a keypad 1000 could also be used by third party couriers, so that each driver might have a PIN. This would make it possible to change the program of the box 200 to disallow the use of a particular PIN, for example, if a driver left the delivery company. In addition, the PIN and keypad 1000 may be used to monitor who accesses the drop box 200.

More specifically, the wireless access card system may be used to control opening and closing of the electric lock assembly 175 on the drop-box 200. The access card 900 has a communication chip and small microprocessor and an antenna. The card 900 also has a button, when the button is pushed, a signal is transmitted to the lock communication chip that may include a string of digits.

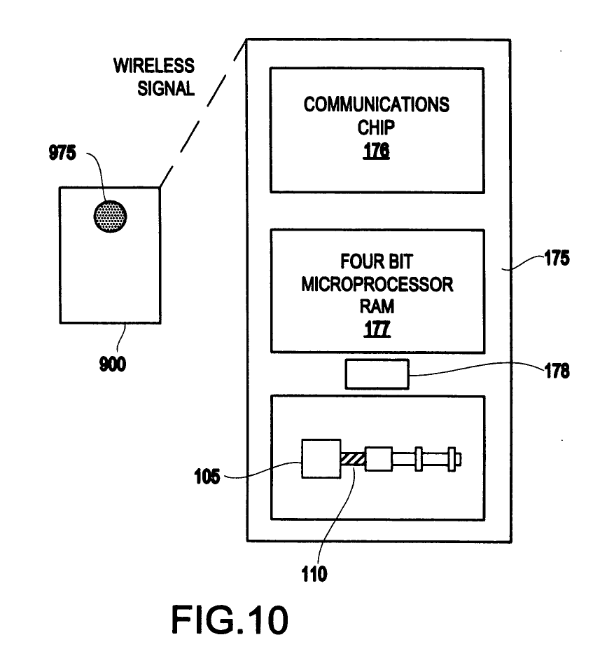

Referring again to the circuit diagram in FIG. 6, and the lock assembly 175 and access card 900 in FIG. 10, the assembly 175 may include a transceiver 176 (e.g., a communications chip) for receiving a wireless signal which may cause the assembly to open/close. The electric lock assembly 175 may also include a four-bit microprocessor with Random Access Memory (RAM) 177 and flash memory 178 for storage of ID codes. The processor may be programmed to have one or several ID codes that can be used to open the lock assembly 175. These components are all low power and can operate without consuming any significant power.

Alternatively, the assembly 175 may be electrically connected to the circuitry in the drop-box 200 including the transceiver in the drop-box. Thus, the assembly 175 may receive (e.g., via its own transceiver or the drop-box transceiver) the digits from the access card 900 (or electronic tag 210). The assembly 175 may then compare the digits to the stored list and if a match is found, the assembly opens (e.g., causes the lock member 120 to be retracted back towards the drive motor 105). In addition, the lock assembly 175 may store the time and date of the transaction as a log. This makes it possible to occasionally harvest the data stored in the lock assembly 175 using the same wireless communication path to confirm all transactions.

The lock may have an optional detector that determines if the door or lid is open or closed. If it is in the closed position, the lock assembly 175 may close (e.g., cause the lock member 120 to move to a position near the strike member 130) automatically after a brief period (e.g., 10 seconds). It is also possible to program the lock assembly 175 to close only if it receives (e.g., wirelessly receives) a close signal, such as wirelessly transmitted by the access card 900. This could be as a result of pushing the same button on the access card 900 used to open the lock, or may be a separate “close” button.

In some high security applications the access card 900 can optionally have a ten digit keypad that requires the user to enter in a four or five digit pin number. The card can transmit both an ID and the pin number to provide positive identification of the person attempting to open the lock.

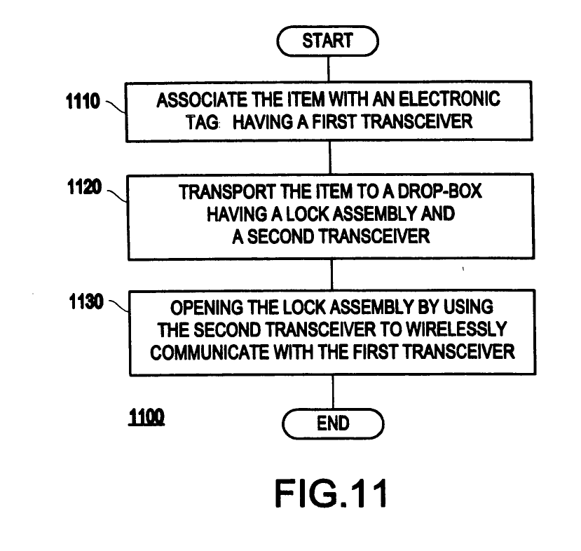

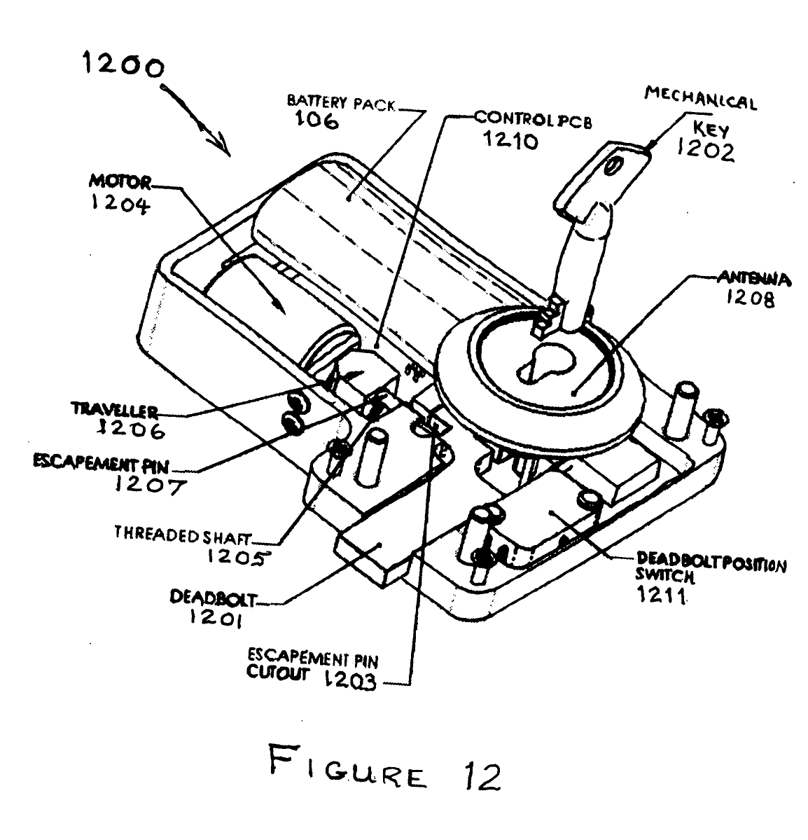

Referring again to the drawings, FIG. 11 provides a flowchart illustrating an inventive method 1000 for delivery of goods using a drop-box 200 which includes the inventive lock assembly 175. As shown in FIG. 11, the inventive method 1100 includes associating (1110) the item with an electronic tag comprising a first transceiver, transporting (1120) the item to the drop box further comprising a second transceiver, and opening (1130) the lock assembly by using the second transceiver to wirelessly communicate with the first transceiver.

The present invention includes many advantages over conventional locks and delivery systems. For example, the lock assembly 175 can be placed into a door without any external mechanical mechanism so it is tamper resistant. For example, it can be easily mortised into the door directly with having the dead-bolt (e.g., lock member) sticking out. In other words, it may have a low cost installation.

Further, the lock assembly 175 can also be attached to rear surface of door as a dead-bolt. Thus, only a few minutes and few screws are needed for installation, resulting in a low cost installation.

In addition, the lock assembly 175 can keep data log of opening and closing and attempted opening and closings (e.g., of the drop-box or other container on which the assembly is used), including time and date of opening/closing, card ID, and PIN owner information. Thus, for example, the assembly 175 is useful in security applications on containers used for customs, as well as drop-boxes used for delivery and pickup of parcels.

Further, many different lock assemblies 175 can be created for different applications using the same basic design. For example, steel shipping containers used on ships can have a very heavy steel bolt. In this case, the motor and thread may be optimized to produce optimum (e.g., maximum) battery life based on the heavy weight of bolt. On the other hand, smaller, lighter bolts can also be used for relay boxes or even apartment mailboxes. In other words, how the lock assembly 175 is tuned via thread and motor may depend on the application.

Further, the mechanics of the lock assembly 175 (e.g., drive motor, threaded rod, lock member, etc.) are simple and are not found in conventional locking mechanisms. This (e.g., only having one (or two) moving part) leads to high reliability for the inventive lock assembly.

For instance, a complex lock is disclosed in Chin, Automatic Locking/Unlocking Device and Method Using Wireless Communication (U.S. Pat. No. 5,942,985). In the Chin lock, a pilot signal is transmitted in an idle state and the lock waits for reception of a wireless reception signal, including a lock access code. This has the disadvantage of consuming power from the transmission of the pilot signal from the lock.

The inventive lock assembly 175, on the other hand, does not transmit a pilot signal which allows the assembly 175 to conserve power. The assembly 175 may include a receiver that waits for an access card (or electronic tag) to transmit a signal (e.g., an ID number or ID/PIN combination if it is a pin card). An acknowledgment may be transmitted back to access card (or electronic tag) after the signal is read by the lock assembly 175. Thus, in the inventive system, it is the access card (or electronic tag) that may transmit a signal to initiate the open/close (e.g., unlock/lock) sequence. Further, the lock assembly may receive the wireless signal and make a decision to unlock (or lock) and record the transaction in the data log. This minimizes power consumption. Therefore, the Chin lock results in more power consumption and lower battery life than the inventive lock assembly because of the pilot signal requirement.

Further, one problem with conventional locks is the high cost to replace the batteries in each drop box (e.g., $20), plus waste problem of disposing of spent batteries. With the claimed lock apparatus, however, the inventors have now recorded 300,000 openings/closings with D batteries and 40,000 openings/closings with AA batteries.

Further, conventional locks do not customize the windings and threads and are very complex. The claimed lock apparatus, however, may be very inexpensive to produce, and may have a battery life greater than 5 yrs. In addition, it is very simple, having two moving parts (i.e., the motor and traveler).

Specifically, as pitch is increased the time required to open/close the lock is decreased (i.e., speed is increased), but the torque required to turn the motor is increased. Thus, by decreasing the pitch, the current required to open/close the lock is spread over time, and the torque required by the motor is decreased.

In fact, the inventive lock apparatus has such a long life that the bore of the traveler may be worn away before the batteries are spent. Therefore, to help ensure that the lock will last at least as long as the battery, the bore may be reinforced (e.g., teflon coated) in order to increase the number of cycles the bore can withstand before wearing away.

Further, the characteristics of the deadbolt affects the torque required to open/close the lock. For example, the heavier the bolt, the more torque (and, therefore, more power) required to open/close the lock. In addition, the longer the throw (i.e., the distance the deadbolt has to travel to latch the lock) the more power consumed.

Thus, the preferred number of windings in the motor may be based, at least in part, on the weight of the deadbolt and the throw. If the windings are increased too much, the motor won't turn, but if the windings are too few, the motor turns to fast (Note that the speed of the motor is determined by number of windings, the throw is determined by the length of thread, and speed (i.e., the time required to open/close the lock) is determined by thread pitch. The thread pitch should be as high as possible because the faster the lock is opened/ closed, the less power the motor consumes. However, if the thread pitch is too high, the cost is high and the threads will get clogged.

Thus, there is an optimal combination of windings and thread pitch depending on the application. The optimum number of windings and thread pitch for a particular application are best determined empirically and depend on many factors (e.g., weight of deadbolt, orientation of the motor (e.g., vertical, horizontal, etc.). An objective is to minimize the time to open/close and at the same time maximize battery life (i.e., minimize power consumption).

With its unique and novel aspects, the present invention provides a lock apparatus (and lock assembly) which has a low power consumption. The lock apparatus and assembly may be used in drop-boxes and delivery systems and methods incorporating the low-power lock assembly, to provide a low-cost, simple, secure locking mechanism, the batteries of which seldom, if ever, need to be replaced or recharged.

### Fifth Embodiment

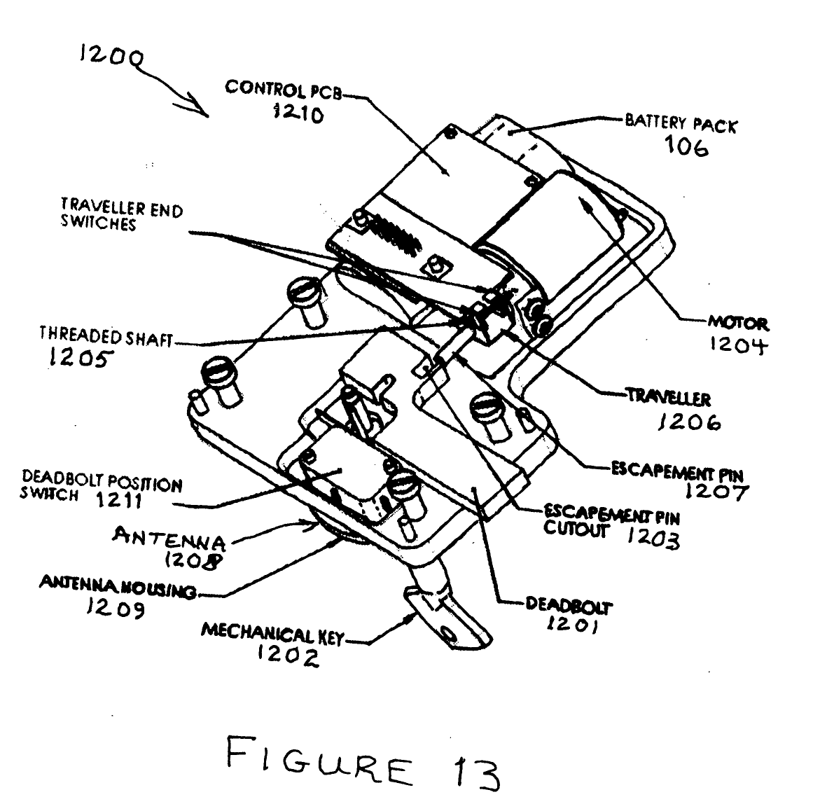

As a fifth embodiment, the present invention provides (as illustrated by way of mere example by FIGS. 12 and 13) an integrated mechanical and electric lock assembly for locking together a first member (e.g. doorframe of a drop-box) and a second member (e.g. door of drop-box) with a deadbolt member 1201 carried by the aforesaid first member, the lock assembly comprising:
a) a first lock assembly 1200, carried by the aforesaid first member, comprising:
   i) a mechanical lock adapted to be carried by the aforesaid first member and operable by a mechanical key 1202 to move an unimpeded deadbolt member 1201 along a first path, the aforesaid deadbolt member 1201 having a cutout 1203 therein and substantially transversely oriented to the aforesaid first path;
   ii) a drive motor 1204 adapted to be carried by the aforesaid first member and having a finite power supply 106, the aforesaid drive motor 1204 comprising a rotatable shaft and a predetermined number of windings;
   iii) a threaded rod 1205 axially connected to the aforesaid shaft, the aforesaid rod 1205 comprising a predetermined thread pitch,
   iv) a traveller 1206 comprising a threaded bore which mates with the aforesaid threaded rod 1205 so that rotation of the aforesaid threaded rod 1205 causes the aforesaid traveller 1206 to move along a second path substantially parallel to the aforesaid threaded rod 1205 and substantially transverse to the aforesaid first path;
   v) an escapement pin 1207 carried by the aforesaid traveller 1206, the aforesaid escapement pin 1207 having a leading end; and
b) a deadbolt strike (not shown) carried by the aforesaid second member (e.g. door of a drop-box), the aforesaid strike having an opening for receiving said leading end of the aforesaid deadbolt member 1201 into a locking position thereof so as to lock the aforesaid first and second members, the aforesaid escapement pin being operable to engage the aforesaid cutout 1203 in the aforesaid deadbolt member 1201 as an escapement pin strike to lock the aforesaid deadbolt member into the aforesaid locking position thereof A deadbolt position switch 1211 may also be provided, as shown.

Preferably, the aforesaid first lock assembly 1200 further comprises a printed circuit board 1210 (control PCB 1210) carrying a first transceiver and an antenna 1208 operable to receive radio frequency signals (e.g. at 300 Hz or other low frequency) from a second transceiver spaced away from said lock assembly to control said drive motor 1204 and consequent movement of said escapement pin 1207 into and out of said cutout 1203 in said deadbolt member 1201.

To simplify replacement of existing prior art locks, the first lock assembly 1200 is preferably proportioned to a size that permits substitution in the field. For this purpose, it is preferable that the aforesaid antenna 1208 be disposed in a compact configuration incorporated into said first lock assembly 1200. For example, the compact configuration can comprise a coil disposed around a keyhole operable to receive the aforesaid mechanical key 1202.

While a preferred embodiment of the present invention has been described above, it should be understood that it has been provided as an example only. Thus, those skilled in the art will recognize that the invention can be practiced with modification within the spirit and scope of the appended claims.

1. A low-power lock apparatus comprising:
a drive motor connected to a finite power supply, said drive motor comprising a shaft and a predetermined number of windings; and
a threaded rod axially connected to said shaft, said rod comprising a predetermined thread pitch,
wherein at least one of said number of windings and said thread pitch are selected to maximize a life of said finite power supply.

2. An electric lock comprising:
a drive motor having a finite power supply, said drive motor comprising a shaft and a predetermined number of windings;
a threaded rod axially connected to said shaft, said rod comprising a predetermined thread pitch,
a traveller comprising a threaded bore which mates with said threaded rod so that rotation of said threaded rod causes said traveller to move along an axis of said threaded rod; and
a lock member which contacts said traveller,
wherein at least one of said number of windings and said thread pitch are selected to maximize a life of said finite power supply.

3. An electric lock assembly comprising:
a drive motor connected to a first member and having a finite power supply, said drive motor comprising a shaft and a predetermined number of windings;
a threaded rod axially connected to said shaft, said rod comprising a predetermined thread pitch,
a traveller comprising a threaded bore which mates with said threaded rod so that rotation of said threaded rod causes said traveller to move along an axis of said threaded rod;
a lock member which contacts said traveller, said lock member having a leading end; and
a strike connected to a second member, said strike having an opening for receiving said leading end so as to lock said first and second members,
wherein at least one of said number of windings and said thread pitch are selected to maximize a life of said finite power supply.

4. The low-power lock apparatus according to claim 1, wherein said finite power supply
supplies pulses of electricity to said drive motor, and at least one of said number of windings and said thread pitch are selected so as to reduce said pulses to a level selected for maximum battery life.

5. The low-power lock apparatus according to claim 4, wherein said finite power supply
comprises a AA-type battery, and wherein said pulses are each less than 100 milliamps and said number of windings is twice the windings of a conventional motor.

6. The low-power lock apparatus according to claim 5, wherein said pulses comprise approximately 50 milliamp pulses.

7. A drop box comprising the electric lock assembly according to claim 3, said lock assembly controlling an access to said drop-box.

8. The drop box according to claim 7, wherein said first member comprises a wall of said
drop box and said second member comprises a door of said drop box.

9. A system utilizing the drop box according to claim 7 for delivery of an item, said system
comprising:
an electronic tag associated with said item and comprising a first transceiver,
wherein said drop box is located at a destination for said item, and further comprises a second transceiver which wirelessly communicates with said first transceiver to open said lock assembly.

10. The system according to claim 9, further comprising:
an access card comprising a third transceiver, for wirelessly communicating with said second transceiver to open said lock assembly.

11. The system according to claim 9, wherein said drop box further comprises a first memory
device for storing a first identification number, and wherein said electronic tag further comprises a second memory device for storing a second identification number.

12. The system according to claim 9, wherein said drop box further comprises a processor for
comparing said first identification number and said second identification number, and wherein said drop box unlocks when said first identification number matches said second identification number.

13. A method utilizing the drop box according to claim 7 for delivery of an item, said method
comprising:
associating said item with an electronic tag comprising a first transceiver;
transporting said item to said drop box further comprising a second transceiver; and
opening said lock assembly by using said second transceiver to wirelessly communicate with said first transceiver.

14. A programmable storage medium tangibly embodying a program of machine-readable
instructions executable by a digital processing apparatus to perform a method utilizing the drop box according to claim 7 for delivery of an item, said method comprising:
associating said item with an electronic tag comprising a first transceiver;
transporting said item to said drop box further comprising a second transceiver; and
opening said lock assembly by using said second transceiver to wirelessly communicate with said first transceiver.

15. An integrated mechanical and electric lock assembly for locking together a first member and a second member with a deadbolt member carried by said first member, the lock assembly comprising:
a) a first lock assembly, carried by said first member, comprising:
i) a mechanical lock adapted to be carried by said first member and operable by a mechanical key to move an unimpeded deadbolt member along a first path, said deadbolt member having a cutout therein and substantially transversely oriented to said first path;
ii) a drive motor adapted to be carried by said first member and having a finite power supply, said drive motor comprising a rotatable shaft and a predetermined number of windings;
iii) a threaded rod axially connected to said shaft, said rod comprising a predetermined thread pitch,
iv) a traveller comprising a threaded bore which mates with said threaded rod so that rotation of said threaded rod causes said traveller to move along a second path substantially parallel to said threaded rod and substantially transverse to said first path;
v) an escapement pin carried by said traveller, said escapement pin having a leading end; and
b) a deadbolt strike carried by said second member, said strike having an opening for receiving said leading end of said deadbolt member into a locking position thereof so as to lock said first and second members, said escapement pin being operable to engage said cutout in said deadbolt member as an escapement pin strike to lock said deadbolt member into said locking position thereof.

16. A lock assembly as set forth in claim 15, wherein at least one of said number of windings and said thread pitch are selected to maximize a life of said finite power supply.

17. A lock assembly as set forth in claim 15, said lock assembly further comprising a first transceiver and an antenna operable to receive radio frequency signals from a second transceiver spaced away from said lock assembly to control said drive motor and consequent movement of said escapement pin into and out of said cutout in said deadbolt member.

18. A lock assembly as set forth in claim 17, said antenna being disposed in a compact configuration incorporated into said first lock assembly.

19. A lock assembly as set forth in claim 18, said compact configuration comprising a coil disposed around a keyhole operable to receive said mechanical key.

20. A drop box comprising the integrated mechanical and electric lock assembly according to claim 15, said lock assembly controlling an access to said drop-box.

21. The drop box according to claim 20, wherein said first member comprises a wall of said drop box and said second member comprises a door of said drop box.
